(19) United States
(12) Patent Application Publication
(10) Pub. No.: US 2003/0111519 A1
(43) Pub. Date: Jun. 19, 2003

(54) Fluxing compositions

(75) Inventors: Robert J. Kinney, Woodbury, MN (US); Michael A. Kropp, Cottage Grove, MN (US); Scott B. Charles, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 09/946,013

(22) Filed: Sep. 4, 2001

(51) Int. Cl. B23K 1/20; B23K 31/02; B23K 35/34

(52) U.S. Cl. 228/223; 228/180.22; 148/23

(57) ABSTRACT

The present invention provides for a chelate fluxing agent, its use in fluxing compositions, and its use in soldering methods. The fluxing agents as described herein, when combined with a resin such as thermosetting resins, thermoplastic resins or a combination thereof, afford compositions suitable for use as underfill adhesives. The present invention also provides for an electrical component assembly and methods for producing an electrical component assembly including such underfill adhesive compositions.

### FIELD OF THE INVENTION

This invention relates to fluxing compositions, use of the fluxing compositions in electrical interconnection methods, and integrated circuits derived therefrom.

### BACKGROUND OF THE INVENTION

Flip-chip technology, including controlled collapse chip connection (C⁴) and direct chip attachment (DCA) techniques, is becoming more popular in the electronics industry as a means to attach integrated circuits (IC) to printed wiring boards (PWB). Flip-chip technology involves inverting and bonding a semi-conductor chip having solder bumps formed on the active side of the semi-conductor chip to a substrate through the solder bumps by reflowing the solder. The structural solderjoints formed between the semi-conductor chip and the substrate create mechanical and electrical connections between the chip and substrate while leaving a narrow gap. These techniques however, result in problems with thermal coefficient of expansion (TCE) mismatch between chip and substrate carrier. Due to the TCE mismatch between the silicon IC and organic substrate PWB, subsequent temperature cycling excursions generate thermomechanical stresses to the solderjoints and result in performance degradation of packaged systems.

Capillary underfill materials are used to fill the narrow gap between the chip and substrate. These underfill materials reinforce the physical, mechanical and electrical properties of the solder joints connecting the chip and the substrate thus preventing degradation of electrical conductivity and providing significant improvement in resisting thermomechanical stresses caused by thermal excursions. The underfill material is typically dispensed around two adjacent sides of the semiconductor chip, then the underfill material slowly flows by capillary action to fill the gap between the chip and the substrate. The underfill material is then thermally hardened.

The distance underfill materials can flow via capillary action is a function of the material's viscosity, the size of the chip, and the height of the gap between the chip and substrate. Thus, the composition of capillary underfills, if possible, must comply with the viscosity requirements imposed by the height of the gap between the chip and substrate as well as the size of the chip. Often these constraints limit the size of the chip that can be used. Furthermore the use of capillary underfill material detrimentally affects production because the reflow process is separated from the underfilling process which results in lower production efficiency.

During flip-chip assembly a flux is placed on the chip or substrate. Then the integrated circuit is placed on the substrate. The assembly is subjected to a solder reflowing thermal cycle, soldering the chip to the substrate. After reflow, due to the close proximity of the chip to the substrate, removing flux residues from under the chip is a difficult operation. Therefore the flux residues are generally left in the space between the chip and the substrate. These residues are known to corrode the solder interconnects resulting in a reduction of reliability of the device.

No-flow, or pre-applied, underfilling processes were developed to dispense the underfill materials on the substrate or the semiconductor devices at first, then perform the solder bump reflowing and underfill encapsulant curing simultaneously. Therefore, no-flow underfilling processes not only eliminate the strict limits on the viscosity of underfill materials and package size, but also improve the production efficiency.

No-flow underfills may be used in conjunction with fluxing agents. Unlike capillary underfills, where the fluxing agent is added in a separate step prior to solder reflow and curing of the underfill material, no-flow underfill materials may be combined with the fluxing agent so that solder reflow and curing of the underfill material occur in one step. Fluxing agents, usually organic acids remain part of the cured underfill after reflow. The use of organic acid fluxing agents in no-flow materials results in corrosive residues that can corrode the solder interconnects in the cured underfill material. Fluxing adhesives that rely on liquid or easily volatilized anhydrides for fluxing activity may be difficult to bond or may provide bondlines that contain voids after curing. These voids can lead to premature solder fatigue failure in underfill applications. Furthermore, adhesives that rely on strongly acidic agents for fluxing activity can have poor shelf life or premature gelation or both, inhibiting solder flow. In contrast, fluxing underfill materials where the fluxing agent is not strongly acidic, such as those disclosed herein, and which become covalently bound in the resulting polymer matrix only during solder reflow and cure, avoid the problems of poor shelf life and premature gelation. Alternatively, fluxing agents may be eliminated from the no-flow process altogether. Insufficient fluxing activity to remove metal oxides, however, detrimentally effects solder wettability and solder spread during reflow.

Accordingly, there is a need for non-corrosive compositions suitable for no-flow underfilling applications in flip-chip technology that reinforce the physical, mechanical and electrical properties of the solder joints connecting the chip and the substrate and that provide the desired solder wettability and solder spread during reflow.

### SUMMARY OF THE INVENTION

In one aspect, the invention includes a composition suitable for use as an underfill adhesive that includes a thermosetting resin; and a fluxing agent selected from compounds of the formulae:

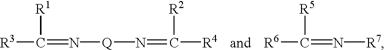

where

Q is arylene, alkylene, alkenylene, cycloalkylene, cycloalkenylene, heterocyclylene or heteroarylene;

R¹, R², and R⁵, are independently H or C₁-C₆ alkyl;

R³and R⁴ are independently alkyl, cycloalkyl, aryl, heteroaryl, heterocyclyl substituted with at least one group selected from —OH or —SH provided that R³ and R⁴ are not phenyl monosubstituted at the 3- or 4-position with hydroxyl; and

R⁶, R⁷, are independently alkyl, cycloalkyl, aryl, heteroaryl, or heterocyclyl where at least one of R⁶ or R⁷ is substituted with at least one group selected from —OH or —SH; and

where said composition is free of anhydride compounds.

In another aspect, the invention includes a composition, as described above, in film form.

In another aspect, the invention includes a composition that includes a fluxing agent selected from compounds of the formulae:

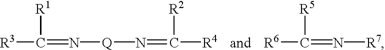

where

Q is arylene, alkylene, alkenylene, cycloalkylene, cycloalkenylene, heterocyclylene or heteroarylene;

R¹, R², and R⁵, are independently H or C₁-C₆ alkyl;

R³ and R⁴ are independently alkyl, cycloalkyl, aryl, heteroaryl, heterocyclyl substituted with at least one group selected from —OH or —SH provided that R³ and R⁴ are not phenyl monosubstituted at the 3- or 4-position with hydroxyl; and

R⁶, R⁷, are independently alkyl, cycloalkyl, aryl, heteroaryl, or heterocyclyl where at least one of R⁶ or R⁷ is substituted with at least one group selected from —OH or —SH; and

where said composition promotes metallurgical wetting and reflow of said metals.

In another aspect, the invention includes a method of soldering that includes the steps of:

a) applying a flux composition to a soldering portion of a work, the flux composition includes a compound selected from the formulae:

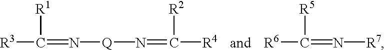

where

Q is arylene, alkylene, alkenylene, cycloalkylene, cycloalkenylene, heterocyclylene or heteroarylene;

R¹, R², and R⁵, are independently H or C₁-C₆ alkyl;

R³ and R⁴, are independently alkyl, cycloalkyl, aryl, heteroaryl, heterocyclyl substituted with at least one group selected from —OH or —SH; and

R⁶ and R⁷ are independently alkyl, cycloalkyl, aryl, heteroaryl, or heterocyclyl where at least one of R⁶ or R⁷ is substituted with at least one group selected from —OH or —SH; and

b) heating said soldering portion to soldering reflow temperatures.

In yet another aspect, the invention includes an electrical component assembly that includes an electrical component having a plurality of electrical terminations, each termination including a solder bump;

a component carrying substrate having a plurality of electrical terminations corresponding to the terminations of the electrical component; and

an adhesive composition disposed between and bonding the electrical component and the substrate together, the solder bumps being reflowed and electrically connecting the electrical component to the substrate, the adhesive composition includes the reaction product of a thermosetting resin and a fluxing agent selected from compounds of the formulae:

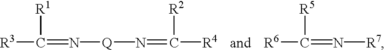

where

Q is arylene, alkylene, alkenylene, cycloalkylene, cycloalkenylene, heterocyclylene or heteroarylene;

R¹, R², and R⁵, are independently H or C₁-C₆ alkyl;

R³ and R⁴, are independently alkyl, cycloalkyl, aryl, heteroaryl, heterocyclyl substituted with at least one group selected from —OH or —SH; and

R⁶ and R⁷ are independently alkyl, cycloalkyl, aryl, heteroaryl, or heterocyclyl where at least one of R⁶ or R⁷ is substituted with at least one group selected from —OH or —SH.

In a further aspect, the invention includes a method of bonding an electrical component assembly that includes the steps of providing an electrical component having a plurality of electrical terminations, each termination including a solder bump;

providing a component carrying substrate having a plurality of electrical terminations corresponding to the terminations of the electrical component;

providing a sufficient amount of an adhesive composition onto the substrate or electrical component;

contacting the electrical component or substrate with the composition; and

curing the composition;

where the composition includes a thermosetting resin; and a fluxing agent selected from compounds of the formulae

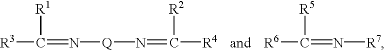

where

Q is arylene, alkylene, alkenylene, cycloalkylene, cycloalkenylene, heterocyclylene or heteroarylene;

R¹, R², and R⁵, are independently H or C₁-C₆ alkyl;

R³ and R⁴, are independently alkyl, cycloalkyl, aryl, heteroaryl, heterocyclyl substituted with at least on group selected from —OH or —SH; and

R⁶ and R⁷ are independently alkyl, cycloalkyl, aryl, heteroaryl, or heterocyclyl where at least one of R⁶ or R⁷ is substituted with at least one group selected from —OH or —SH.

### DETAILED DESCRIPTION OF THE INVENTION

All numbers are herein assumed to be modified by the term “about.”

The recitation of numerical ranges by endpoints includes all numbers subsumed within that range (e.g. 1 to 5 includes 1, 1.5, 2, 2.75, 3, 3.80, 4, and 5).

For the following defined terms, these definitions shall be applied, unless a different definition is given in the claims or elsewhere in this specification.

As used herein, the term “alkyl” refers to a straight or branched chain monovalent hydrocarbon radical having a specified number of carbon atoms. Alkyl groups include those with one to twenty carbon atoms. Alkyl groups may be unsubstituted or substituted with those substituents that do not interfere with the specified function of the composition. Substituents include alkoxy, hydroxy, mercapto, amino, alkyl substituted amino, or halo, for example. Examples of “alkyl” as used herein include, but are not limited to, methyl, ethyl, n-propyl, n-butyl, n-pentyl, isobutyl, and isopropyl, and the like.

As used herein, the term “alkylene” refers to a straight or branched chain divalent hydrocarbon radical having a specified number of carbon atoms. Alkylene groups include those with one to twenty carbon atoms. Alkylene groups may be unsubstituted or substituted with those substituents that do not interfere with the specified function of the composition. Substituents include alkoxy, hydroxy, mercapto, amino, alkyl substituted amino, or halo, for example. Examples of “alkylene” as used herein include, but are not limited to, methylene, ethylene, propane-1,3-diyl, propane-1,2-diyl and the like.

As used herein, the term “alkenylene” refers to a straight or branched chain divalent hydrocarbon radical having a specified number of carbon atoms and one or more carbon-carbon double bonds. Alkenylene groups include those with one to twenty carbon atoms. Alkenylene groups may be unsubstituted or substituted with those substituents that do not interfere with the specified function of the composition. Substituents include alkoxy, hydroxy, mercapto, amino, alkyl substituted amino, or halo, for example. Examples of “alkenylene” as used herein include, but are not limited to, ethene-1,2-diyl, propene-1,3-diyl, and the like.

As used herein, “cycloalkyl” refers to an alicyclic hydrocarbon group having a specified number of carbon atoms. Cycloalkyl groups include those with one to twelve carbon atoms. Cycloalkyl groups may be unsubstituted or substituted with those substituents that do not interfere with the specified function of the composition. Substituents include alkoxy, hydroxy, mercapto, amino, alkyl substituted amino, or halo, for example. Such a cycloalkyl ring may be optionally fused to one or more of another heterocyclic ring(s), heteroaryl ring(s), aryl ring(s), cycloalkenyl ring(s), or cycloalkyl rings. Examples of “cycloalkyl” as used herein include, but are not limited to, cyclopropyl, cyclobutyl, cyclopentyl, cyclohexyl, cycloheptyl, or cyclooctyl, and the like.

As used herein, the term “cycloalkenyl” refers to an alicyclic monovalent hydrocarbon radical having a specified number of carbon atoms and at least one carbon-carbon double bond in the ring system. Cycloalkenyl groups include those with one to twelve carbon atoms. Cycloalkenyl groups may be unsubstituted or substituted with those substituents that do not interfere with the specified function of the composition. Substituents include alkoxy, hydroxy, mercapto, amino, alkyl substituted amino, or halo, for example. Such a cycloalkenyl ring may be optionally fused to one or more of another heterocyclic ring(s), heteroaryl ring(s), aryl ring(s), cycloalkenyl ring(s), or cycloalkyl rings. Examples of “cycloalkenyl” as used herein include, but are not limited to, cyclopentenyl, cyclohexenyl, and the like.

As used herein, the term “cycloalkylene” refers to an alicyclic divalent hydrocarbon radical having a specified number of carbon atoms. Cycloalkylene groups include those with one to twelve carbon atoms. Cycloalkylene groups may be unsubstituted or substituted with those substituents that do not interfere with the specified function of the composition. Substituents include alkoxy, hydroxy, mercapto, amino, alkyl substituted amino, or halo, for example. Such a cycloalkylene ring may be optionally fused to one or more of another heterocyclic ring(s), heteroaryl ring(s), aryl ring(s), cycloalkenyl ring(s), or cycloalkyl rings. Examples of “cycloalkylene” as used herein include, but are not limited to, cyclopropyl-11-diyl, cyclopropyl-1,2-diyl, cyclobutyl-1,2-diyl, cyclopentyl-1,3-diyl, cyclohexyl-1,2-diyl, cyclohexyl-1,3-diyl cyclohexyl-1,4-diyl, cycloheptyl-1,4-diyl, or cyclooctyl-1,5-diyl, and the like.

As used herein, the term “cycloalkenylene” refers to a substituted alicyclic divalent hydrocarbon radical having a specified number of carbon atoms and at least one carbon-carbon double bond in the ring system. Cycloalkenylene groups include those with one to twelve carbon atoms. Cycloalkenylene groups may be unsubstituted or substituted with those substituents that do not interfere with the specified function of the composition. Substituents include alkoxy, hydroxy, mercapto, amino, alkyl substituted amino, or halo, for example. Such a cycloalkenylene ring may be optionally fused to one or more of another heterocyclic ring(s), heteroaryl ring(s), aryl ring(s), cycloalkenyl ring(s), or cycloalkyl rings. Examples of “cycloalkenylene” as used herein include, but are not limited to, 4,5-cyclopentene-1,3-diyl, 4,5-cyclohexene-1,2-diyl, and the like.

As used herein, the term “heterocyclic” or the term “heterocyclyl” refers to a monovalent three to twelve-membered non-aromatic ring containing one or more heteroatomic substitutions independently selected from S, O, or N and having zero to five degrees of unsaturation. Heterocyclyl groups may be unsubstituted or substituted with those substituents that do not interfere with the specified function of the composition. Substituents include alkoxy, hydroxy, mercapto, amino, alkyl substituted amino, or halo, for example. Such a heterocyclic ring may be optionally fused to one or more of another heterocyclic ring(s), heteroaryl ring(s), aryl ring(s), cycloalkenyl ring(s), or cycloalkyl rings. Examples of “heterocyclic” as used herein include, but are not limited to, tetrahydrofuryl, pyranyl, 1,4-dioxanyl, 1,3-dioxanyl, piperidinyl, pyrrolidinyl, morpholinyl, tetrahydrothiopyranyl, tetrahydrothiophenyl, and the like.

As used herein, the term “heterocyclylene” refers to a divalent three to twelve-membered non-aromatic heterocyclic ring radical containing one or more heteroatoms independently selected from S, O, or N and having zero to five degrees of unsaturation. Heterocyclylene groups may be unsubstituted or substituted with those substituents that do not interfere with the specified function of the composition. Substituents include alkoxy, hydroxy, mercapto, amino, alkyl substituted amino, or halo, for example. Such a heterocyclylene ring may be optionally fused to one or more of another heterocyclic ring(s), heteroaryl ring(s), aryl ring(s), cycloalkenyl ring(s), or cycloalkyl rings. Examples of “heterocyclylene” as used herein include, but are not limited to, tetrahydrofuran-2,5-diyl, morpholine-2,3-diyl, pyran-2,4-diyl, 1,4-dioxane-2,3-diyl, 1,3-dioxane-2,4-diyl, piperidine-2,4-diyl, piperidine-1,4-diyl, pyrrolidine-1,3-diyl, morpholine-2,4-diyl, and the like.

As used herein, the term “aryl” refers to monovalent unsaturated aromatic carbocyclic radicals having a single ring, such as phenyl, or multiple condensed rings, such as naphthyl or anthryl. Aryl groups may be unsubstituted or substituted with those substituents that do not interfere with the specified function of the composition. Substituents include alkoxy, hydroxy, mercapto, amino, alkyl substituted amino, or halo, for example. Such an aryl ring may be optionally fused to one or more of another heterocyclic ring(s), heteroaryl ring(s), aryl ring(s), cycloalkenyl ring(s), or cycloalkyl rings. Examples of “aryl” as used herein include, but are not limited to, phenyl, 2-naphthyl, 1-naphthyl, biphenyl, 2-hydroxyphenyl, 2-aminophenyl, 2-methoxyphenyl and the like.

As used herein, the term “arylene” refers to divalent unsaturated aromatic carbocyclic radicals having a single ring, such as phenylene, or multiple condensed rings, such as naphthylene or anthrylene. Arylene groups may be unsubstituted or substituted with those substituents that do not interfere with the specified function of the composition. Substituents include alkoxy, hydroxy, mercapto, amino, alkyl substituted amino, or halo, for example. Such an “arylene” ring may be optionally fused to one or more of another heterocyclic ring(s), heteroaryl ring(s), aryl ring(s), cycloalkenyl ring(s), or cycloalkyl rings. Examples of “arylene” as used herein include, but are not limited to, benzene-1,2-diyl, benzene-1,3-diyl, benzene-1,4-diyl, naphthalene-1,8-diyl, anthracene-1,4-diyl, and the like.

As used herein, the term “heteroaryl” refers to a monovalent five-to seven-membered aromatic ring radical containing one or more heteroatoms independently selected from S, O, or N. Heteroaryl groups may be unsubstituted or substituted with those substituents that do not interfere with the specified function of the composition. Substituents include alkoxy, hydroxy, mercapto, amino, alkyl substituted amino, or halo, for example. Such a “heteroaryl” ring may be optionally fused to one or more of another heterocyclic ring(s), heteroaryl ring(s), aryl ring(s), cycloalkenyl ring(s), or cycloalkyl rings. Examples of “heteroaryl” used herein include, but are not limited to, furyl, thiophenyl, pyrrolyl, imidazolyl, pyrazolyl, triazolyl, tetrazolyl, thiazolyl, oxazolyl, isoxazolyl, oxadiazolyl, thiadiazolyl, isothiazolyl, pyridinyl, pyridazinyl, pyrazinyl, pyrimidinyl, quinolinyl, isoquinolinyl, benzofuryl, benzothiophenyl, indolyl, and indazolyl, and the like.

As used herein, the term “heteroarylene” refers to a divalent five-to seven-membered aromatic ring radical containing one or more heteroatoms independently selected from S, O, or N. Heteroarylene groups may be unsubstituted or substituted with those substituents that do not interfere with the specified function of the composition. Substituents include alkoxy, hydroxy, mercapto, amino, alkyl substituted amino, or halo, for example. Such a “heteroarylene” ring may be optionally fused to one or more of another heterocyclic ring(s), heteroaryl ring(s), aryl ring(s), cycloalkenyl ring(s), or cycloalkyl rings. Examples of “heteroarylene” used herein include, but are not limited to, furan-2,5-diyl, thiophene-2,4-diyl, 1,3,4-oxadiazole-2,5-diyl, 1,3,4-thiadiazole-2,5-diyl, 1,3-thiazole-2,4-diyl, 1,3-thiazole-2,5-diyl, pyridine-2,4-diyl, pyridine-2,3-diyl, pyridine-2,5-diyl, pyrimidine-2,4-diyl, quinoline-2,3-diyl, and the like.

As used herein, the term “alkoxy”, refers to —O-alkyl groups wherein alkyl is as defined above.

As used herein, the term “halogen” or “halo” shall include iodine, bromine, chlorine and fluorine.

As used herein, the terms “mercapto” and “sulfhydryl” refer to the substituent —SH.

As used herein, the term “hydroxy” refers to the substituent —OH.

As used herein, the term “hydroxyphenyl” refers to a hydroxy substituted phenyl ring such as 2-hydroxyphenyl or 2,4-dihydroxyphenyl, for example.

As used herein, the term “chelating agent” or “chelation” refers to a compound containing two or more sites within a single molecule that associate with a single metal ion. Examples of chelating agents as used herein include, but are not limited to, 2-[(phenylimino)methyl]phenol, ethylenediamine, 2,2′-bipyridine, 1,10-phenanthroline, o-phenylenebis(dimethylarsine), 1,2-bis(diphenylphosphino)ethane, acetylacetonate, hexafluoroacetylacetonate, salicylaldiminate-8-quinoline, oxalate anion, terpyridine, diethylenetriamine, triethylenetriamine, nitrilotriacetate, and ethylenediaminetetraacetate.

As used herein the term “anhydride” refers to molecules derived from two carboxylic acid moieties with loss of a molecule of water via either an intermolecular or an intramolecular reaction. The term “anhydride” also contemplates mono-, di- and poly-anhydrides. Furthermore, the term “anhydride” as used herein shall not only refer to, and include, the anhydride itself but the corresponding carboxylic acid molecules or dibasic acid molecule from which it is derived. Examples of anhydrides as used herein include, but are not limited to, acetic anhydride (and its corresponding acid, acetic acid), maleic anhydride (and its corresponding acid, maleic acid), hexahydrophthalic anhydride (and its corresponding acid, 1,2-cyclohexanedicarboxylic acid), methyl hexahydrophthalic anhydride (i.e., hexahydro-4-methylphthalic anhydride, and its corresponding acid, 4-methyl-1,2-cyclohexanedicarboxylic acid), phthalic anhydride (and its corresponding acid, phthalic acid), malic anhydride (and its corresponding acid, malic acid), acrylic-furoic anhydride (and its corresponding acids, furoic acid and acrylic acid), bromosuccinic anhydride (and its corresponding acid, bromosuccinic acid).

As used herein the term “fluxing agent” refers to a material that removes metal oxides from the surfaces of metals to promote metallurgical wetting and reflow of said metals.

As used herein the term “substantially free of anhydride compounds” means the weight percent of anhydride compounds in a given composition is less than 0.05 weight percent.

As used herein, the term “free of anhydride compounds” means the weight percent of anhydride compounds in a given composition is zero.

As used herein, the term “thermosetting” refers to a material, usually a high polymer, which solidifies or sets irreversibly when heated. This property is usually associated with a cross-linking reaction of the molecular constituents induced by heat or radiation. The term “thermoset” as used herein refers to a thermosetting material, which has been cured. A thermosetting material may generally be cured by application of heat, actinic radiation such as UV, visible, or infrared, or microwave or X-ray energy.

As used herein the term “thermoplastic” refers to a material which undergoes a physical change upon the application of heat, i.e., the material flows upon bonding and returns to its initial non-flowing state upon cooling. A thermoplastic material is typically bonded by application of heat.

As used herein the term “weight percent” refers to the mass of an individual substance divided by the total mass of the composition, multiplied by 100. Weight percentages as recited herein do not take into account additional additives such as silica, glass and polymeric microballoons, expandable polymeric microballoons, pigments, thixotropic agents, toughening agents, or cure indicating materials, for example.

The present invention provides for a chelate fluxing agent, its use in fluxing compositions, and its use in soldering methods. The fluxing agents as described herein, when combined with a resin such as thermosetting resins, thermoplastic resins or a combination thereof, afford compositions suitable for use as underfill adhesives, no-flow underfill adhesives, fluxing adhesives and wafer-applied adhesives. The fluxing agents of these compositions react with the resins upon cure and become covalently immobilized in the polymer network. The compositions as described herein reinforce the physical, mechanical and electrical properties of the solder joints connecting the chip and the substrate and avoid the problems associated with corrosion of the solder interconnects due to the inability of the fluxing agent to migrate through the polymer network to the solder joints.

The chelate fluxing agents as provided for herein include those having both an aromatic hydroxyl oxygen atom and an imino group which are separated by two atoms (e.g., two carbon atoms) from each other (i.e., located on an atom beta to each other). The beta atom refers to those atoms located in a position beta to either the carbon or the nitrogen atoms of the imino group, or both.

Examples of chelate fluxing agents as provided for herein include Schiff base type compounds of the formulae I and II shown below.

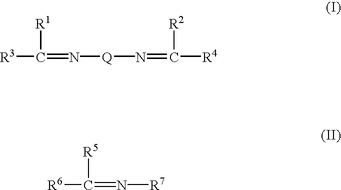

The fluxing agents of formulae I and II include those where Q is arylene, alkylene, alkenylene, cycloalkylene, cycloalkenylene, heterocyclylene or heteroarylene; R¹, R², and R⁵, are independently H or C₁-C₆ alkyl; R³, R⁴ R⁶ and R⁷ are independently alkyl, cycloalkyl, aryl, heteroaryl, heterocyclyl substituted with at least one group selected from —OH and —SH.

Fluxing agents of formulae I and II include those where Q is arylene, alkylene, alkenylene, cycloalkylene, cycloalkenylene, heterocyclylene or heteroarylene; R¹, R², and R⁵, are independently H or C₁-C₆ alkyl; R³ and R⁴ are independently alkyl, cycloalkyl, aryl, heteroaryl, heterocyclyl substituted with at least one group selected from —OH and —SH provided that R³ and R⁴ are not phenyl monosubstituted at the 3- or 4-position with hydroxyl (the 1-position being that which attaches to the carbon of the imine moiety); and R⁶ and R⁷ are independently alkyl, cycloalkyl, aryl, heteroaryl, or heterocyclyl where at least one of R⁶ or R⁷ is substituted with at least one group selected from —OH and —SH.

Additionally, fluxing agents of formulae I and II include those where Q is arylene, alkylene, or cycloalkylene; fluxing agents where R³ and R⁴ are independently aryl substituted with at least one group selected from —OH and —SH provided that R³ and R⁴ are not 1,3- or 1,4- substituted hydroxyphenyl; and fluxing agents where R⁶ and R⁷ are independently alkyl, cycloalkyl, aryl, heteroaryl, or heterocyclyl where at least one of R⁶ or R⁷ is substituted with at least one group selected from —OH and —SH.

Furthermore, fluxing agents of formulae I and II include those where Q is benzene-1,2-diyl, benzene-1,3-diyl, benzene-1,4-diyl, ethylene, propane-1,3-diyl, propane-1,2-diyl, cyclohexyl-1,2-diyl, cyclohexyl-1,3-diyl, or cyclohexyl-1,4-diyl; R³ and R⁴ are 2-hydroxyphenyl; and R⁶ and R⁷ are independently phenyl, 2-hydroxyphenyl, 3-hydroxyphenyl, or 4-hydroxyphenyl.

Fluxing agents within the scope of the present invention not only include the Schiff bases disclosed above but also fluxing agents capable of acting as chelating agents for metal ions. Though not wishing to be bound by any particular theory, it is believed that the Schiff bases disclosed herein act as chelating agents for the metal ion in the metal oxides present on the surface of metals to be soldered. The theory includes the belief that metal ions from the surface of the metals to be soldered associate with a combination of Schiff base nitrogen(s) and the sulfur or oxygen atoms of the hydroxyl or mercapto groups present in the R³, R⁴ R⁶ and R⁷ substituents. Thus, the Schiff bases disclosed herein, and other molecules capable of acting as chelating agents for metal ions, act as fluxing agents by providing protons to the metal oxides and by effectively associating, removing and sequestering the metal ions of the metal oxides from the surfaces of the metals to be soldered. The mechanism for the fluxing activity of the fluxing agents disclosed herein differs greatly from that of traditional fluxing agents, such as acidic fluxing agents, in that chelation contributes strongly to the action of the flux agent with the metal ions to remove the metal oxides from the surface.

Fluxing agents are present in the compositions of the invention at various levels including levels greater than 5 weight percent, greater than 16 weight percent, greater than 20 weight percent, and greater than 30 weight percent. Fluxing agents are typically present in the compositions of the invention at levels greater than 5 weight percent.

Fluxing compositions of the present invention remove metal oxides from the surfaces of metals to promote metallurgical wetting and reflow of said metals and include a fluxing agent or agents selected from those of formulae I and II.

The compositions of the invention can additionally contain one or more thermosetting resins. Thermosetting resins as disclosed herein include polyepoxide resins, cyanate ester resins, and bis-maleimide resins. Useful polyepoxide resins include, for example, substituted or unsubstituted aliphatic, cycloaliphatic, aromatic and/or heterocyclic polyepoxides, such as glycidyl esters, glycidyl ethers, glycidyl amines, or epoxidized olefins, and combinations thereof.

Specific examples of polyepoxide resins useful in the compositions of the present invention include, but are not limited to, diglycidyl ethers of bisphenol A and diglycidyl ethers of bisphenol F, aliphatic monoglycidyl ethers, aliphatic diglycidyl ethers, aliphatic multifunctional glycidyl ethers, and aliphatic glycidyl esters.

Examples of useful polyepoxide resins that are diglycidyl ethers of bisphenol A include, but are not limited to, EPON™ Resins 825, 826, and 828, available from Resolution Performance Productions, Houston, Tex.; D.E.R.™ 330, 331, and 332, available from Dow Chemical Company, Midland, Mich.; and ARALDITE™ GY 6008, GY 6010, and GY 2600, available from Vantico, Brewster, N.Y.

Examples of useful polyepoxide resins that are diglycidyl ethers of bisphenol F include, but are not limited to, EPON™ Resin 862, available from Resolution Performance Productions, Houston, Tex.; and ARALDITE™ GY 281, GY 282, GY 285, PY 306, and PY 307, available from Vantico, Brewster, N.Y.

Examples of useful mono, di and multifunctional glycidyl ether resins include, but are not limited to, XB 4122, MY0510, TACTIX™ 556 and TACTX™ 742, available from Vantico, Brewster, N.Y.; and EPON™ 1510, HELOXY™ Modifier 107, HELOXY™ Modifier 48, available from Resolution Performance Productions, Houston, Tex.

The polyepoxide resins are preferably purified so that they are substantially free of ionic species.

Removal of residual ionic halogens can be accomplished by first reacting the polyepoxide resin with a base. The base is present in an amount which exceeds the molar equivalent based on the materials comprising hydrolyzable halide. This amount depends on the starting polyepoxide resin. For example, if no other acids are present, a theoretical amount of base can be used based on the level of hydrolyzable halide, commonly expressed in parts per million (ppm). In other situations, for example, 100 percent to 200 percent base is required.

The polyepoxide resin may be combined with a base at room temperature to form a mixture or in other situations, the polyepoxide resin may be pre-heated. Thus, the heating and agitation step may occur prior to and during the reaction with the base, simultaneously with the base treatment step, or after the base is added to the polyepoxide resin. The starting polyepoxide resin dictates this order.

The selection of the base depends upon the starting polyepoxide resin. Examples of suitable bases useful in the process of the present invention include, but are not limited to, hydroxides such as potassium hydroxide in water, sodium hydroxide, and lithium hydroxide, hydrides such as lithium hydride, sodium hydride (optionally in mineral oil), and potassium hydride, alkoxides such as primary, secondary, and tertiary (e.g., potassium t-butoxide in tetrahydrofuran (THF) alkoxides such as sodium ethoxide, carbonates such as potassium carbonate and sodium carbonate, and quaternary ammonium salts.

Generally, the base strength and the temperature are such that the halohydrin closes to the epoxy and under which the epoxy does not polymerize. For example, in one case for an epichlorohydrin-derived polyepoxide resin, potassium t-butoxide in THF was suitable at 25° C., but the resin polymerized at 70° C.

The use of non-nucleophilic bases such as sodium hydride are believed to have the advantageous effect of closing the halohydrin without reacting appreciably with other base (hydrolytically) sensitive functionality such as esters.

If a non-nucleophilic base is used, the process of the present invention preferably comprises the following steps: (a) distilling a polyepoxide resin comprising materials containing hydrolyzable halide using molecular distillation to yield an epoxy distillate; and (b) reacting said epoxy distillate with a base wherein said base is present in a quantity which exceeds the molar equivalent based on the materials containing hydrolyzable halide.

The initial distillation step removes moisture along with high molecular weight materials containing hydroxyl functionality. The product can either be neutralized with water and carbon dioxide to remove residual sodium hydride before distillation or can be distilled directly without neutralization.

The mixture is heated to a temperature suitable for reaction of the halohydrin to form the epoxy while agitated. For example, the mixture may be heated using a heat mantel. Generally, the mixture is heated between 20° C. to 200° C. for 1 minute to 12 hours. However, the temperature and time depend upon the starting polyepoxide resin, base strength and solubility, the catalytic activity of the base towards polyepoxide polymerization, and commercial viability.

This heating and mixing can occur after the polyepoxide resin and base are combined, prior to and during the base treatment step, or simultaneously with the addition of the base and base treatment step.

The mixture is usually heated to alter the viscosity which in turn helps the dispersion of the base.

The heated mixture is then neutralized, if required, using carbon dioxide to form a crude product. With the hydrides, this neutralization step may not be required. Optionally, at this point, residual salts may be removed from the crude product by filtration.

Next, the crude product is isolated by molecular distillation to yield the product. For example, a rolled film evaporator or wipe film evaporator may be used. With a rolled film evaporator, the crude product is distributed across a vertical heated surface by an efficient, self-cleaning roller wiper system into a uniform thin film. The evaporated material travels a short distance to an internal condenser. A smaller vacuum is used with low operating temperatures. (See UIC Inc., “Short Path Vacuum Distillation from Laboratory to Production”, 1997). With a wipe film evaporator, a wiper is used instead of the self-cleaning roller wiper.

The distillation conditions depend on the boiling point of the crude product.

Noncondensible materials which may be the starting materials, that is, the polyepoxide resin, are removed during molecular distillation.

The yielded epoxy product has low levels of hydrolyzable halide, that is, from 1 to 100 ppm, preferably less than 10 ppm, more preferably less than 1 ppm.

Specific examples of cyanate ester resins useful in the compositions of the present invention include AroCy™ B-10, AroCy™ M-10, AroCy™ L-10, Primaset™ PT-30, AroCy™ XU366 and Primaset™ LECY available from Vantico, Brewster, N.Y.

Specific examples of bismaleimide resins useful in the compositions of the present invention include the N,N′-bismaleimides of 1,2-ethanediamine, 1,6-hexanediamine, trimethyl-1,6-hexanediamine, 1,4-benzenediamine, 4,4′-methylene-bis(benzenamine), 2-methyl-1,4-benzenediamine, 3,3′-methylene-bis(benzenamine), 3,3′-sulfonyl-bis(benzenamine), 4,4′-sulfonyl-bis(benzenamine), 3,3′-oxy-bis(benzenamine), 4,4′-oxy-bis(benzenamine), 4,4′-methylene-bis(cyclohexanamine), 1,3-benzenedimethanamine, 1,4-benzenedimethanamine, and 4,4′-cyclohexane-bis(benzenamine) and mixtures thereof. Other N,N′-bis-maleimides and their process of preparation are described in U.S. Pat. Nos. 3,562,223; 3,627,780; 3,839,358; and 4,468,497, all of which are incorporated herein by reference.

Representative examples of commercially available bismaleimide materials include the series of materials available from Resolution Performance Productions, Houston, Tex. under the trade designation “COMPIMIDE” such as 4,4′-bismaleimidodiphenyl methane (“COMPIMIDE Resin MDAB”), and 2,4′-bismaleimidotoluene (“COMPIMIDE Resin TDAB”), and from Dexter/Quantum, San Diego, Calif. under the trade designation “Q-Bond”.

Thermosetting resins are present in the compositions of the invention at various levels including levels greater than 50 weight percent, greater than 70 weight percent, greater than 80 weight percent, and greater than 90 weight percent. Thermosetting resins are typically present in the compositions of the invention at levels greater than 50 weight percent.

The compositions of the present invention optionally, but preferably contain one or more catalysts when a thermosetting resin is present. The function of the catalysts in the compositions of the invention is to accelerate curing of the thermosetting resin. Useful catalysts are those that promote epoxy epoxy homopolymerization as well as coreaction of the fluxing agent with the polyepoxide resin. Additionally, useful catalysts are latent under ambient conditions but are activated to accelerate reactions when heated above a temperature of 80° C. or greater. Classes of useful catalysts include substituted imidazoles, metal acetylacetonates, metal acetates, metal halides, metal imidazole complexes, and metal amine complexes. Metals useful in the previously mentioned classes of catalysts include Sc³⁺, Cu²⁺, Mo²⁺, Ru³⁺, Rh³⁺, Cd²⁺, La³⁺, Hf⁴⁺, In³⁺, Tl¹⁺, Tl³⁺, Pb³⁺, Ti⁴⁺, Ce³⁺, Ce⁴⁺, Pr³⁺, Eu³⁺, Gd³⁺, Tb³⁺, Dy³⁺, Ho³⁺, Er³⁺, Tm³⁺, Lu³⁺, Th³⁺, Co²⁺, Co³⁺, Fe²⁺, Fe³⁺, Ni²⁺, Pd²⁺, Pt²⁺, Ga³⁺, Y³⁺, V³⁺, Sm³⁺, Nd³⁺, Cr³⁺, Li¹⁺, Be²⁺, K¹⁺, Ca²⁺, Na¹⁺, Ba²⁺, Sr²⁺, Zn²⁺, Mg²⁺, or Ag¹⁺. Typical catalysts include metal imidazole complexes, such as zinc imidazolate and copper imidazolate, for example, as well as substituted imidazoles, such as 4,5-diphenylimidazole, for example. Catalysts are present in the compositions of the invention at a level of 0.02 to 10 weight percent, 0.05 to 5 weight percent, or 0.25-2 weight percent, for example.

The compositions of the present invention are substantially free of anhydride compounds. Preferably, compositions of the present invention are free of anhydride compounds. Generally, anhydride compounds act as curing agents in adhesive compositions. Anhydride compounds typically function as a reactant or crosslinking agent for polyepoxide resins and can also react with hydroxyl containing compounds to form an acid in-situ which functions as a fluxing agent. The use of anhydride curing agents and their in-situ production of acid fluxing agents produces many of the problems discussed above such as corrosion of solder interconnects resulting in reduction of the reliability of a device.

While it is preferred that the compositions of the present invention are free of anhydride compounds, they may contain one or more curing agents. Such curing agents include imides, amines, carboxylic acids, amides, anhydrides, alcohols/phenols, aldehydes/ketones, nitro compounds, nitrites, carbamates, isocyanates, amino acids/peptides, thiols, sulfonamides, semicarbazones, oximes, hydrazones, cyanohydrins, ureas, phosphoric esters/acids, thiophosphoric esters/acids, phosphonic esters/acids, phosphites, phosphonamides, or other agents known to those skilled in the art to cure polymers.

The compositions of the invention may contain one or more thermoplastic resins. Thermoplastic resins as disclosed herein include polyether imides, polyether sulfones, phenoxy resins, polyvinylbutyral resins, and polyphenylene ethers, polycarbonates, polyesters, ethylene vinyl acetate (EVA), polyurethanes, polyamides, polyolefins, and derivatives thereof.

Thermoplastic resins are present in the compositions of the invention at a level less than 30 weight percent, less than 20 weight percent, less than 15 weight percent, or less than 5 weight percent.

The compositions disclosed herein include those in film form. Typically, a thermoplastic resin is incorporated into the compositions disclosed herein to produce a film form underfill material. However, any film forming process known to those of skill in the art may be applied to the compositions disclosed herein to produce a film form underfill material. Film forming processes include, for example, the process for forming acrylate/epoxy hybrid blends where an acrylate network is formed in an epoxy monomer matrix to produce an adhesive film prior to polymerization of the epoxy resin. Such film forming processes include those disclosed in U.S. Pat. Nos. 5,086,088, 5,721,289, 4,552,612, and 4,612,209, herein incorporated by reference.

Underfill compositions of the present invention in film form include wafer-applied underfill materials and no-flow underfill materials. The advantages of an underfill material in such a film form include the ability to apply the film to an entire silicon wafer of integrated circuit chips prior to dicing of the wafer into individual chips. This allows for the mass application of underfill material to integrated circuit chips as opposed to individually applying the underfill material to each chip as is required of non-film, no-flow underfill materials.

The compositions of the invention may contain additional additives that are known to those skilled in the art. Such classes of additives include but are not limited to fillers such as silica; glass and polymeric microballoons, expandable polymeric microballoons, pigments, thixotropic agents, toughening agents, cure indicating materials, flame retardants, fibers, conducting particles, and combinations thereof. Additives are present in the compositions of the invention at a level to effect the desired result.

Generally, the thermosetting resin and fluxing agent are mixed together with stirring, preferably under an inert atmosphere, with heat until homogeneous. The temperature at which the mixture is heated is dependent upon the structure and mix ratio of the thermosetting resin and the fluxing agent and generally ranges from about 100 to about 180° C. However, in some cases, where the fluxing agent is a liquid for example, there may be no need for additional heating. After the thermosetting resin and fluxing agent are blended to form a mixture, the catalyst is blended into the thermosetting resin-fluxing agent mixture at reduced pressures.

The compositions of the invention may be cured by exposure to a temperature profile used to reflow eutectic solder. For example, a useful temperature profile includes ramping from ambient temperature to 150° C. at 90° C./minute, isothermally holding the system for approximately 1 minute, then ramping to 220-240° C. at 90° C./minute, and finally cooling the system to ambient temperatures at 60° C./min. While it is preferred that no additional curing steps are needed, some embodiments of the present invention may include a post-cure step of 150° C.-170° C. for 0.5 to 2 hours.

The compositions of the invention may be cured by exposure to a temperature profile used to reflow lead-free solder. For example, a useful temperature profile includes ramping from ambient temperature to 180° C. at 90° C./minute, isothermally holding the system for approximately 1.5 minutes, then ramping to 240-280° C. at 90° C./minute, and finally cooling the system to ambient temperatures at 60° C./min. While it is preferred that no additional curing steps are needed, some embodiments of the present invention may include a post-cure step of 150° C.-170° C. for 0.5 to 2 hours.

The fluxing agents and compositions of the present invention are useful in a variety of soldering methods. Such soldering method include those where a fluxing agent or flux composition of the present invention is applied to a soldering portion of a work to remove metallic oxides form the surfaces of the metals to be joined and to promote metallurgical wetting of these metals. Such soldering methods further include the step of heating the soldering portion to solder reflow temperatures.

A soldering portion of a work includes a plurality of metals, or any metallic components, joinder of which is desired. Typical soldering portions of a work include electrical components such as wires, soldering pads, and solder balls, as well as metallic structural components such as housings, for example. Soldering portions of a work are commonly composed of copper, tin, lead, palladium, platinum, silver, chrome, titanium, or nickel for example.

Soldering reflow temperatures will depend on the metallurgy of the solder and soldering portion of the work. Solders may contain, but are not limited to, alloys of tin, lead, bismuth, indium, cadmium, gallium, zinc, antimony, copper, silver, and other materials known to those skilled in the art of soldering. Most solders are alloys of tin and lead. Depending on the percentages of each component, the melting point will vary. For example the soldering reflow temperatures for tin/lead solder (63% tin and 37% lead) is 183° C. while that of lead/indium solder is 220° C. An example of a lead-free solder is an alloy of copper, tin and silver in a ratio of 0.5/95.5/4.0, respectively, and it has a reflow temperature of 217° C. One of skill in the art would recognize the appropriate soldering temperatures for the material involved in a given soldering process.

The compositions and resulting adhesive compositions of the present invention are useful in soldering processes to attach solder bumped flip-chips to a substrate and as an underfill adhesive for surface mounted components in general to provide environmental protection for the surface mounted components. It should be appreciated that although the discussion below is directed toward an integrated circuit connected to a substrate, embodiments using other types of surface mounted components having solder bumps are within the scope of the invention.

Electrical component assemblies of the present invention and methods for their production include providing an electrical component having a plurality of electrical terminations and a component-carrying substrate having a plurality of electrical terminations corresponding to the terminations of the electrical component. The electrical component includes such devices as integrated circuit chips where each electrical termination includes a solder bump, for example. The substrate includes such substrates as printed wiring boards where each electrical termination includes a solder pad, for example. Each of the solder pads is metallized so as to become solderable and electrically conductive to provide an electrical interconnection between the electrical component and the substrate.

The substrate is selectively coated with a sufficient amount of a composition of the present invention by screen printing, stenciling, depositing a preform, or other dispensing means. Optionally, the electrical component or both the electrical component and the substrate are coated with a composition of the present invention. Where the composition of the present invention is in film form, the film is typically applied to the electrical component. The film may contain voids so as to allow the electrical terminations to protrude through the film or the electrical terminations may be exposed through the removal of film covering the electrical terminations by mechanical or chemical means. The electrical component is then positioned so that the electrical terminations (e.g. solder bumps) are aligned with the electrical terminations (e.g. solder pads) of the substrate. The composition is generally applied such that it covers either the entire surface of the electrical component, the substrate, or both, while the fluxing agent contained in the composition cleans the electrical terminations of both the substrate and the electrical component of metal oxides. The assembly is reflowed in a conventional manner, causing the fluxing agent to become activated, reducing the oxides on the solder bumps and the solder pads, while permitting alloying of the solder to the metal. During the reflow process, the adhesive composition crosslinks to at least the gel point. Depending on the chemistry of the utilized adhesive system, a second post curing operation may be required to completely cure the adhesive composition.

The invention will be further characterized by the following examples. These examples are not meant to limit the scope of the invention which has been fully set forth in the foregoing description.

### Test Methods

Solder Spread—Neat

The fluxing activity of the compounds described herein was evaluated by observing their ability to promote solder spread on a test substrate of copper metal. Specifically, a small amount (typically about 0.10 grams) of the compound was placed on a piece of copper metal measuring two inches long by one inches wide by 0.010 inches thick. Next, ten eutectic solder balls (63:37/tin:lead, w/w), having a diameter of 0.025 inches, were placed on the compound, after which the copper test piece was put on a hot plate preheated to 302° F. (150° C.) as measured at the surface. After heating the copper test piece for one minute the hot plate was reset to bring its surface temperature to 437° F. (225° C.) to melt the solder balls (the melting point of the eutectic is about 361° F. (183° C.). If the solder balls were observed to melt and spread beyond their original dimension, the compound was judged to exhibit fluxing activity and was given a grade of “Pass”. If the solder balls did not spread beyond their original dimension, the compound was given a grade of “Fail”.

Solder Spread—in Blend with Polyepoxide Resin

The fluxing activity of the compounds described herein, when blended with a polyepoxide resin, was evaluated by observing the ability of the blend to promote solder spread on a copper clad FR-4 board (a cured composite of glass cloth/epoxy resin) which had its surface covered with an organic solder preservative (OSP) or a gold plated nickel coating. Straight-line conductive traces, having a width of 0.010 inches, were formed by use of a solder mask. The board was then cut across its width to give pieces measuring about 0.5 inches wide and about 2 inches long, with the traces running in the 0.5 inch direction. Each compound was blended with RSL 1462 polyepoxide resin (a liquid polyepoxide resin having a low chloride content, available from Resolution Performance Productions, Houston, Tex.) at a loading level of 30 weight percent. The blend was flood-coated over the board sample having traces such that the thickness of the blend was about 0.003 inches greater than the height of the solder mask. Next, a 0.025 inch diameter eutectic solder ball (63:37/tin:lead, w/w) was placed in the blend and pressed down gently to make contact with each trace. The board was passed through a reflow oven having the following time/temperature profile: ramp from ambient temperature (20-25° C.) to 150° C. at 90° C./minute, hold isothermal for approximately 1.5 minutes, ramp to a temperature of 220 to 240° C. at 90° C./minute, and then cool at 60° C./ minute to ambient temperature. This profile ensured that the solder balls would exceed their melt temperature. If the solder balls were observed to melt and spread beyond their original dimension, the blend was judged to exhibit fluxing activity and was given a grade of “Pass”. If the solder balls did not spread beyond their original dimension, the blend was given a grade of “Fail”. In all cases, the solder spread did not exceed the area of the traces that was covered by blend of polyepoxide resin and fluxing agent compound.

### Purification of Polyepoxide Resins

Some of the polyepoxide resins used herein were purified to remove ionic impurities (e.g., chloride ions) and to make them substantially free of hydroxyl functionality. The procedure used was that described previously.

### Preparation of 2,2′-[1,2-propane-bis(nitrilomethylidyne)]bisphenol

### Example 6

A bis-Schiff base was prepared from 1,2-propanediamine and salicylaldehyde for evaluation as a fluxing agent in the following manner. Three hundred and sixty-eight grams (3.01 moles) of salicylaldehyde (available as catalog #S35-6 from Aldrich Chemical Company, Milwaukee, Wis.) was placed in a one liter, open-head reaction flask fitted with a reflux condenser, mechanical stirrer and a pressure equalizing dropping funnel. One hundred and eleven grams (1.5 moles) of 1,2-propanediamine (available as catalog #11,749-8 from Aldrich Chemical Company, Milwaukee, Wis.) was added from the dropping funnel at a rate that maintained the temperature of the reaction mixture below 70° C. After the addition was completed, the reaction mixture was stirred for one hour at ambient conditions (20-25° C.). The reaction mixture and two hundred and fifty milliliters of toluene were transferred to a one liter round bottom flask fitted with a Dean-Stark trap and reflux condenser. The mixture was heated to reflux and the distillate was collected in the Dean-Stark trap. The distillate separated into two phases. The mixture was heated at reflux until no more phase separation occurred in the distillate. The Dean-Stark trap was removed, a vacuum distillation head was added, and the reaction mixture was heated slowly, under reduced pressure, until a small amount of distillate was collected. The distillate contained salicylaldehye and toluene. The reaction product did not distill. Infrared and NMR analysis (in CDCl₃) of the reaction product indicated the reaction product was free of salicylaldehyde and 1,2-propanediamine. Some crystallization of the reaction product occurred. The reaction product weighed 379 grams (1.34 moles).

### Preparation of Aldehyde-Amine Adducts

### Examples 1-5 and 7-13, and Comparative Examples 1-3

Various adducts were prepared from benzaldehyde derivatives and aromatic or aliphatic (di)amines for evaluation as fluxing agents. The term “(di)amine” is used to indicate both mono- and di-amine adducts. The same general procedure was used for each one. The preparation of bis-salicylidene-1,3-phenylene diamine (Example 2) is illustrative of this procedure and was done as follows.

1,3-phenylenediamine (available as catalog #P2,395-4 from Aldrich Chemical Company), 68.4 grams (0.633 moles), was dissolved in 400 milliliters of methanol in a one liter polymerization flask fitted with a mechanical stirrer, dropping funnel and reflux condenser. A solution of salicylaldehyde (154.2 grams, 1.26 moles) in 100 milliliters of methanol was added dropwise to the warmed (40° C.) diamine solution. A yellow precipitate formed during the addition. After all the salicylaldehyde solution was added, the reaction mixture was heated at reflux for one hour. The power to the heating mantle was turned off, and the reaction mixture was allowed to cool, with stirring, to room temperature (20-25° C.). The resulting mixture was filtered and 190 grams (0.60 moles) of a yellow crystalline product was collected after air drying. The melting point (by Differential Scanning Calorimetry at a heating rate of 10° C./ minute) was 102° C. NMR analysis (run in d7-DMF) showed no evidence of either starting material in the product.

### Materials for Examples 27-29 and Comparative Examples 7-9

The following materials were obtained commercially and evaluated as fluxing agents: 4,4′-cyclohexylidene bisphenol; 3,3-bis(4-hydroxyphenyl)-1(3H)-isobenzofuranone; and 4,4′,4″-methylidyne-tris-phenol (all available from Aldrich Chemical Company, Milwaukee, Wis.); 2-[[(2-mercaptophenyl)imino]methyl]phenol (available from TCI America, Portland, Oreg.); 2,2′-[1,4-butane-bis(nitrilomethylidyne)]bisphenol and 2,2′-[1,6-hexane-bis(nitrilomethylidyne)]bisphenol (both available from (available from TCI America, Portland, Oreg.).

### EXAMPLES

### Examples 1-13 and Comparative Examples 1-3

Various compounds were evaluated for fluxing activity. More specifically, the compounds shown in Table 1 below were evaluated for Solder Spread in the neat form as described in the test method “Solder Spread—Neat” above. The results are shown in Table 1. [Note: the systematic nomenclature instituted by Chemical Abstracts Service in the 9^{th} Collective Index period (1972-) was used in naming the compounds shown in Tables 1 and 2].

TABLE 1
Solder Spread - Neat

| | | Result |
|---|---|---|
| Ex | Compound | (Pass/Fail) |
| 1 | 2,2′-[1,4-phenylene-bis(nitrilomethylidyne)]bisphenol | Pass |
| 2 | 2,2′-[1,3-phenylene-bis(nitrilomethylidyne)]bisphenol | Pass |
| 3 | 2,2′-[1,2-phenylene-bis(nitrilomethylidyne)]bisphenol | Pass |
| CE 1 | 4,4′-[1,2-ethane-bis(nitrilomethylidyne)]bisphenol | Fail |
| 4 | 2,2′-[1,3-propane-bis(nitrilomethylidyne)]bisphenol | Pass |
| 5 | 2,2′-[1,2-ethane-bis(nitrilomethylidyne)]bisphenol | Pass |
| 6 | 2,2′-[1,2-propane-bis(nitrilomethylidyne)]bisphenol | Pass |
| 7 | 2-[[(2-hydroxyphenyl)imino]methyl]phenol | Pass |
| 8 | 2-[(phenylimino)methyl]phenol | Pass |
| 9 | 2-[[(3-hydroxyphenyl)imino]methyl]phenol | Pass |
| 10 | 2-[[(4-hydroxyphenyl)imino]methyl]phenol | Pass |
| 11 | 4-[[(2-hydroxyphenyl)imino]methyl]phenol | Pass |
| CE 2 | 4-[[(4-hydroxyphenyl)imino]methyl]phenol | Fail* |
| 12 | 2,2′-[1,2-cyclohexyl-bis(nitrilomethylidyne)]bisphenol | Pass |
| | (cis/trans mixture) | |
| 13 | 2-[(phenylmethylene)amino]phenol | Pass |
| CE 3 | N-(phenylmethylene)-benzenamine | Fail |

CE = Comparative Example
*This compound exhibited solder spread only after discoloring indicating
decomposition may have taken place.
Example 1 and 14

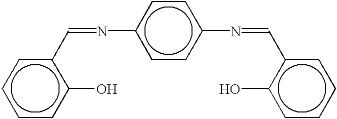

Example 2 and 15

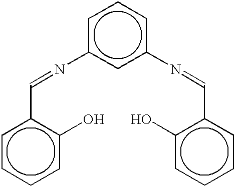

Example 3 and 16

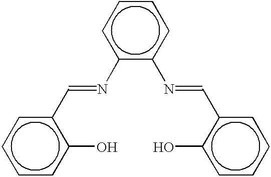

Example 4 and 17

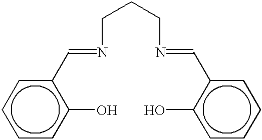

Example 5 and 18

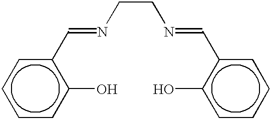

Example 6 and 19

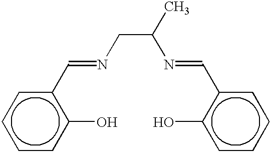

Example 8 and 20

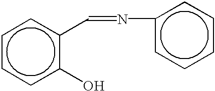

Example 7

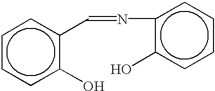

Example 10

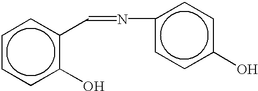

Example 9

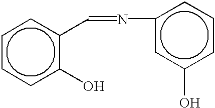

Example 11

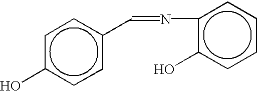

Example 12 and 21

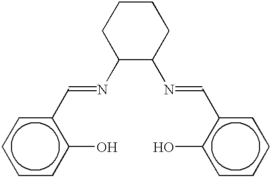

Example 13

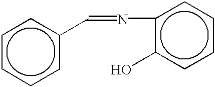

Example CE1 and CE4

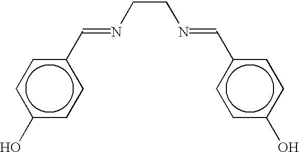

Example CE2 and CE5

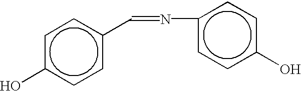

Example CE3

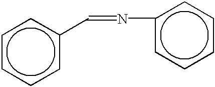

The results in Table 1 show that, for the compounds evaluated, those having both an aromatic hydroxyl oxygen atom and an imino group which are separated by two atoms (eg., two carbon atoms) from each other (i.e., located on an atom beta to each other) exhibited fluxing activity. The beta atom refers to those atoms located in a position beta to either the carbon or the nitrogen atoms of the imino group, or both. This is shown in Examples 8, 13, and 7, respectively.

### Examples 14-24 and Comparative Examples 4-8

Various compounds were blended with polyepoxide resin and evaluated for fluxing activity. More specifically, the compounds shown in Table 2 below were evaluated for Solder Spread after blending with a polyepoxide resin as described in the test method “Solder Spread—in Blend with Polyepoxide Resin” with the following exceptions. Examples 22 and 23 employed the following mixture of purified polyepoxide resins: TACTIX™ 742 (a trifunctional polyepoxide resin, available from Vantico Incorporated, Brewster, N.Y., having an epoxide equivalent weight of about 150 after purification), EPON™ 828 (a diglycidyl ether of bisphenol A, available from Resolution Performance Productions, Houston, Tex., having an epoxide equivalent weight of about 170 after purification), and EPON™ 862 (a diglycidyl ether of bisphenol F, available from Resolution Performance Productions, Houston, Tex., having an epoxide equivalent weight of about 160 after purification) in a 1:1:1 weight ratio. The results are shown in Table 2.

TABLE 2
Solder Spread - in Blend with Polyepoxide Resin

| | | Result |
|---|---|---|
| Ex. | Compound | (Pass/Fail) |
| 14 | 2,2′-[1,4-phenylene-bis(nitrilomethylidyne)]bisphenol | Pass |
| 15 | 2,2′-[1,3-phenylene-bis(nitrilomethylidyne)]bisphenol | Pass |
| 16 | 2,2′-[1,2-phenylene-bis(nitrilomethylidyne)]bisphenol | Pass |
| CE 4 | 4,4′-[1,2-ethane-bis(nitrilomethylidyne)]bisphenol | Fail |
| 17 | 2,2′-[1,3-propane-bis(nitrilomethylidyne)]bisphenol | Pass |
| 18 | 2,2′-[1,2-ethane-bis(nitrilomethylidyne)]bisphenol | Pass |
| 19 | 2,2′-[1,2-propane-bis(nitrilomethylidyne)]bisphenol | Pass |
| 20 | 2-[(phenylimino)methyl]phenol | Fail |
| CE 5 | 4-[[(4-hydroxyphenyl)imino]methyl]phenol | Fail |
| 21 | 2,2′-[1,2-cyclohexyl-bis(nitrilomethylidyne)]bisphenol | Pass |
| | (cis/trans mixture) | |
| 22 | 2,2′-[1,4-butane-bis(nitrilomethylidyne)]bisphenol | Pass |
| 23 | 2,2′-[1,6-hexane-bis(nitrilomethylidyne)]bisphenol | Pass |
| CE 6 | 4,4′-cyclohexylidenebisphenol | Fail |
| CE 7 | 3,3-bis(4-hydroxyphenyl)-1(3H)-isobenzofuranone | Fail |
| CE 8 | 4,4′,4″-methylidynetrisphenol | Fail |
| 24 | 2-[[(2-mercaptophenyl)imino]methyl]phenol | Pass |

CE = Comparative Example
Example 22

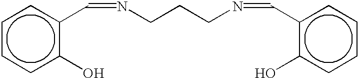

Example 23

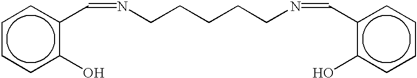

Example 24

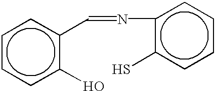

Example CE6

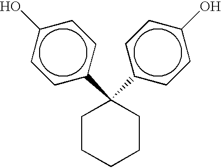

The results in Table 2 show that, for the compounds evaluated, those having both an aromatic hydroxyl oxygen atom and an imino group which are separated by two atoms (e.g., two carbon atoms) from each other (i.e., located on an atom beta to each other) exhibited fluxing activity when blended with a polyepoxide resin. In contrast, when the imino and aromatic hydroxyl groups were not positioned in this manner then fluxing activity was not observed. Fluxing activity was also shown by a blend of an polyepoxide

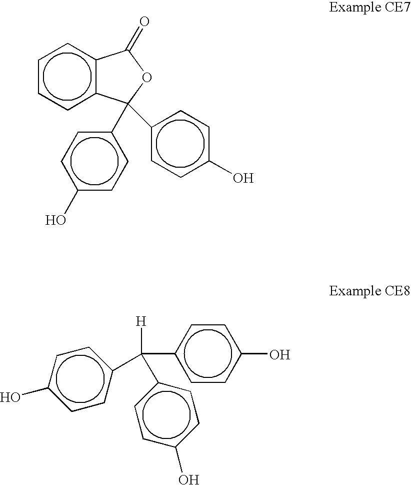

resin and an imino compound having an active hydrogen-containing group located on the atom beta to each atom of the imino group (i.e., the carbon and nitrogen atoms), wherein the active hydrogen-containing groups were different from each other, i.e., an aromatic hydroxyl group and an aromatic mercapto group. It should be noted that although Example 20 failed this test, it passed the “Solder Spread—Neat” test (see Example 8 in Table 1). This indicates the compound may have utility in a form other than in a polyepoxide adhesive composition, eg., as a solution or dispersion in a volatile solvent.

### Example 25

A fluxing adhesive composition containing a fluxing compound of the present invention was prepared and used to bond an integrated circuit chip to a printed circuit board. More specifically, 23.3 parts by weight (pbw) of purified EPON™ 828, 23.3 pbw purified EPON™ 862, 23.3 pbw TACTIX™ 742, and 30.0 pbw of solid 2,2′-[1,2-ethane-bis(nitrilomethylidyne)]bis-phenol (the “imino compound”) were combined and stirred with heating at 120° C. until a light yellow-brown colored homogenous mixture was obtained. The mixture was allowed to cool to ambient temperature (20-25° C.) with stirring under reduced pressure (vacuum pump). During the cooling process, the imino compound precipitated from the mixture. Next, 0.5 pbw copper imidazolate (per 100 pbw of total polyepoxide resin) was added to the mixture which was then stirred at ambient temperature under reduced pressure (vacuum pump) to give an imino compound-containing fluxing adhesive composition.

Five test boards were prepared using the fluxing adhesive composition to bond an integrated circuit chip to a printed circuit test board in the following manner. The fluxing adhesive composition was applied to a 64 pad test pattern area of a printed circuit test board as a small drop from a syringe. The drop was allowed to spread out at ambient temperature. The 64 pad test pattern was connected in a dual Daisy chain test pattern. A silicon integrated circuit chip (0.200 by 0.200 inches), having eutectic tin/lead solder bumps arranged around the perimeter on one surface in a pattern matching the pad pattern on the board, was placed on the board using a Semiautomatic COG Bonder (available from Toray Engineering Company Limited, Osaka, Japan) with a load of 4.4 pounds (2 kilograms) and 3 second dwell time at ambient temperature such that the solder bumps on the chip were aligned with the pads on the board. The board, with the chip in place, was passed through a solder reflow oven to form electrical connections between the pads and the solder bumps on the chip. The solder reflow oven had the following time/temperature profile: ramp from ambient temperature (20-25° C.) to 150° C. at 90° C./minute, hold isothermal for approximately 1.5 minutes, ramp to a temperature of 220 to 240° C. at 90° C./minute, and then cool at 60° C./minute to ambient temperature. A voltmeter was used to confirm that all the solder connections were complete (i.e., they exhibited electrical continuity).

Three of the five test boards prepared were post cured by heating in a forced air oven at 302° F. (150° C.) for one hour. All five boards were then evaluated using a thermal shock test having the following profile (5 minutes at −55° C., 5 minute ramp to 125° C., hold at 125° C. for 5 minutes, 5 minute ramp to −55° C.). After one hundred cycles the connections were checked for electrical continuity. If a discontinuity was found, the board was removed from the test chamber and the number of cycles completed at the last test that did not result in discontinuities was recorded. The results are shown in Table 3 below.

TABLE 3
Thermal Shock Test Results

| | Post Cured | |
|---|---|---|
| Board Number | (Yes/No) | Number of Cycles Passed |
| 1 | Yes | 100 |
| 2 | Yes | 1000 |
| 3 | Yes | 1100 |
| 4 | No | 1000 |
| 5 | No | 1500 |

The results in Table 3 show that a reliable bond between chip and board can be provided using adhesives containing the fluxing compounds of the present invention.

What is claimed is:

1. A composition suitable for use as an underfill adhesive comprising
a thermosetting resin; and
a fluxing agent selected from compounds of the formulae: 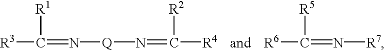
wherein
Q is arylene, alkylene, alkenylene, cycloalkylene, cycloalkenylene, heterocyclylene or heteroarylene;
R¹, R², and R⁵, are independently H or C₁-C₆ alkyl;
R³ and R⁴ are independently alkyl, cycloalkyl, aryl, heteroaryl, heterocyclyl, substituted with at least one group selected from —OH and —SH provided that R³ and R⁴ are not phenyl monosubstituted at the 3- or 4-position with hydroxyl; and
R⁶ and R⁷ are independently alkyl, cycloalkyl, aryl, heteroaryl, or heterocyclyl, wherein at least one of R⁶ or R⁷ is substituted with at least one group selected from —OH and —SH; and
wherein said composition is free of anhydride compounds.

2. The composition of claim 1, wherein the thermosetting resin is a polyepoxide resin, cyanate ester resin, or bismaleimide resin.

3. The composition of claim 2, wherein the polyepoxide resin is selected from glycidyl esters, glycidyl ethers, glycidyl derivatives of amino phenols, glycidyl amines, epoxidized olefins, and combinations thereof.

4. The composition of claim 2, wherein the polyepoxide resin is selected from a diglycidyl ether of bisphenol A, a diglycidyl ether of bisphenol F, a triglycidyl ether of tris(4-hydroxyphenyl)methane, and combinations thereof.

5. The composition of claim 1, wherein Q is arylene, alkylene, or cycloalkylene.

6. The composition of claim 1, wherein Q is benzene-1,2-diyl, benzene-1,3-diyl, benzene-1,4-diyl, ethylene, propane-1,3-diyl, propane-1,2-diyl, cyclohexyl-1,2-diyl, cyclohexyl-1,3-diyl, or cyclohexyl-1,4-diyl.

7. The composition of claim 1, wherein R³ and R⁴ are independently aryl.

8. The composition of claim 1, wherein R³ and R⁴ are 2-hydroxyphenyl.

9. The composition of claim 1, wherein R⁶ and R⁷ are independently aryl.

10. The composition of claim 1, wherein at least one of R⁶ and R⁷ is 2-hydroxyphenyl.

11. The composition of claim 10, wherein R⁶ and R⁷ are independently selected from phenyl, 2-hydroxyphenyl, 3-hydroxyphenyl, and 4-hydroxyphenyl.

12. The composition of claim 1, further comprising a catalyst.

13. The composition of claim 12, wherein the catalyst is selected from substituted imidazoles, metal acetylacetonates, metal acetates, metal halides, metal imidazole complexes, and metal amine complexes.

14. The composition of claim 13, wherein the catalyst is a metal imidazolate or a substituted imidazole.

15. The composition of claim 14, wherein the catalyst is a zinc imidazolate or 4,5-diphenylimidazole.

16. The composition of claim 1, further comprising a curing agent.

17. The composition of claim 1, further comprising silica.

18. The composition of claim 1, further comprising a thermoplastic resin.

19. The composition of claim 18, further comprising silica.

20. A composition comprising a compound selected from the formulae: 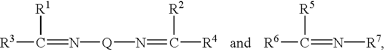
wherein
Q is arylene, alkylene, alkenylene, cycloalkylene, cycloalkenylene, heterocyclylene or heteroarylene;
R¹, R², and R⁵, are independently H or C₁-C₆ alkyl;
R³ and R⁴ are independently alkyl, cycloalkyl, aryl, heteroaryl, heterocyclyl, substituted with at least one group selected from —OH and —SH provided that R³ and R⁴ are not phenyl monosubstituted at the 3- or 4-position with hydroxyl; and
R⁶ and R⁷ are independently alkyl, cycloalkyl, aryl, heteroaryl, or heterocyclyl, wherein at least one of R⁶ or R⁷ is substituted with at least one group selected from —OH and —SH; and
wherein said composition is a film.

21. The composition of claim 20, further comprising silica

22. The composition of claim 20, further comprising a thermoplastic resin.

23. The composition of claim 22, further comprising silica.

24. A composition comprising a compound selected from the formulae: 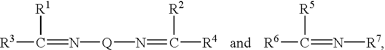
wherein
Q is arylene, alkylene, alkenylene, cycloalkylene, cycloalkenylene, heterocyclylene or heteroarylene;
R¹, R², and R⁵, are independently H or C₁-C₆ alkyl;
R³ and R⁴ are independently alkyl, cycloalkyl, aryl, heteroaryl, or heterocyclyl, substituted with at least one group selected from —OH and —SH, provided that R³ and R⁴ are not phenyl monosubstituted at the 3- or 4-position with hydroxyl; and
R⁶ and R⁷ are independently alkyl, cycloalkyl, aryl, heteroaryl, or heterocyclyl, wherein at least one of R⁶ or R⁷ is substituted with at least one group selected from —OH and —SH; and
wherein said composition promotes metallurgical wetting and reflow of said metals.

25. A method of soldering comprising the steps of:
a) applying a flux composition to a soldering portion of a work, the flux composition comprising a compound selected from the formulae: 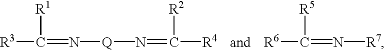
wherein
Q is arylene, alkylene, alkenylene, cycloalkylene, cycloalkenylene, heterocyclylene or heteroarylene;
R¹, R², and R⁵, are independently H or C₁-C₆ alkyl;
R³ and R⁴, are independently alkyl, cycloalkyl, aryl, heteroaryl, or heterocyclyl, substituted with at least one group selected from —OH and —SH; and
R⁶ and R⁷ are independently alkyl, cycloalkyl, aryl, heteroaryl, or heterocyclyl, wherein at least one of R⁶ or R⁷ is substituted with at least one group selected from —OH and —SH; and
b) heating said soldering portion to soldering reflow temperatures.

26. An electrical component assembly comprising:
an electrical component having a plurality of electrical terminations, each termination including a solder bump;
a component carrying substrate having a plurality of electrical terminations corresponding to the terminations of the electrical component; and
an adhesive composition disposed between and bonding the electrical component and the substrate together, the solder bumps being reflowed and electrically connecting the electrical component to the substrate, the adhesive composition comprising the reaction product of:
a thermosetting resin; and
a fluxing agent selected from compounds of the formulae: 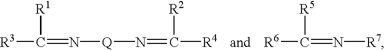
wherein
Q is arylene, alkylene, alkenylene, cycloalkylene, cycloalkenylene, heterocyclylene or heteroarylene;
R¹, R², and R⁵, are independently H or C₁-C₆ alkyl;
R³ and R⁴, are independently alkyl, cycloalkyl, aryl, heteroaryl, or heterocyclyl, substituted with at least one group selected from —OH and —SH; and
R⁶ and R⁷ are independently alkyl, cycloalkyl, aryl, heteroaryl, or heterocyclyl, wherein at least one of R⁶ or R⁷ is substituted with at least one group selected from —OH and —SH.

27. The electrical component assembly of claim 26, wherein said adhesive composition further comprises a catalyst.

28. A method of bonding an electrical component assembly comprising the steps of:
providing an electrical component having a plurality of electrical terminations, each termination including a solder bump;
providing a component carrying substrate having a plurality of electrical terminations corresponding to the terminations of the electrical component;
providing a sufficient amount of an adhesive composition onto the substrate or electrical component;
contacting the electrical component or substrate with the composition; and
curing the composition;
wherein said composition comprises:
a thermosetting resin; and
a fluxing agent selected from compounds of the formulae 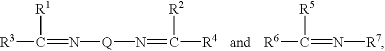
wherein
Q is arylene, alkylene, alkenylene, cycloalkylene, cycloalkenylene, heterocyclylene or heteroarylene;
R¹, R², and R⁵, are independently H or C₁-C₆ alkyl;
R³ and R⁴, are independently alkyl, cycloalkyl, aryl, heteroaryl, or heterocyclyl, substituted with at least one group selected from —OH or —SH; and
R⁶ and R⁷ are independently alkyl, cycloalkyl, aryl, heteroaryl, or heterocyclyl, wherein at least one of R⁶ or R⁷ is substituted with at least one group selected from —OH and —SH.

29. The method of claim 28, wherein said adhesive composition further comprises a catalyst.
